(19) United States
(12) Patent Application Publication
(10) Pub. No.: US 2019/0183190 A1
(43) Pub. Date: Jun. 20, 2019

(54) PORTABLE ARTICLE INCLUDING A NUMBER OF PATTERNS

(71) Applicant: Revolution Cycle Works Company, Charleston, RI (US)

(72) Inventors: Joseph J. Loberti, Saunderstown, RI (US); Karl Langmuir, Providence, RI (US); David A. Durfee, N. Scituate, RI (US)

(73) Assignee: Revolution Cycle Works Company, Charleston, RI (US)

(21) Appl. No.: 16/213,124

(22) Filed: Dec. 7, 2018

Related U.S. Application Data
(60) Provisional application No. 62/599,852, filed on Dec. 18, 2017.

(51) Int. Cl. A41D 13/01; A41B 9/06; A41D 13/00; A45F 3/04

(52) U.S. Cl. CPC A41D 13/01; A41B 9/06; G05D 1/0257; A45F 3/04; A41D 2600/104; A41D 13/0015

(57) ABSTRACT

A portable article includes a portable body and a number of patterns disposed on the portable body. The patterns are selected from the group consisting of public patterns, detectable patterns, visible pattern, embedded patterns, camouflage patterns, invisible patterns, orienting patterns, collective patterns, external patterns, internal patterns, illuminated patterns, applied patterns and three dimensional patterns.

### CROSS REFERENCE TO RELATED APPLICATION

This application claims the benefit of U.S. Provisional Patent Application Ser. No. 62/599,852, filed Dec. 18, 2017, which is incorporated by reference herein.

### BACKGROUND OF THE INVENTION

### Field of the Invention

The disclosed and claimed concept relates to portable articles such as, but not limited to, apparel and accessories and, more specifically, to portable articles including a pattern that is structured to be identified by a detection system.

### Background Information

Apparel, apparel accessories and other accessories are known to include various indicia for a number of purposes. On one hand, some apparel, typically for hunters and soldiers, is structured to blend in with the environment so as to hide the user. Other apparel, typically for those who work near traffic or construction, includes bright and/or contrasting colors so as to make the user visible. From an aesthetic perspective, such apparel is not always desirable or in fashion.

Recent developments in robotics, including self-driving vehicles, have created a need for portable articles that help robots, and more specifically a detection system of the robot, to identify humans, animals, and other objects. As used herein, a “detection system” is any system used to detect the environment. A “detection system” includes at least one of an “imaging system” and/or an “audio sensor system.” As used herein, an “imaging system” is any system that detects/senses light in any form including, but not limited to visible light, radar, infrared light and ultraviolet light. As used herein, an “audio sensor system” is any system that detects/senses sound in any form including, but not limited to, sonar and ultrasound. That is, there is a need for a portable article such as, but not limited to, apparel and accessories, that can be identified by a detection system. Such portable articles need to be light enough for a user to carry much of the time. Such portable articles also need to be something that a user is willing to carry much of the time. For example, depending upon what is fashionable, bright or contrasting colors, which are typically identifiable by detection systems, may not be acceptable to many users. Thus, a portable article including a number of patterns that are acceptable to users is needed.

### SUMMARY OF THE INVENTION

These needs, and others, are met by the disclosed and claimed concept which provides a portable article including a portable body and a number of patterns disposed on the portable body. The patterns are selected from the group consisting of public patterns, detectable patterns, visible patterns, embedded patterns, camouflage patterns, invisible patterns, orienting patterns, collective patterns, external patterns, internal patterns, illuminated patterns, applied patterns and three dimensional patterns. The patterns disclosed herein increase a pedestrian's visibility for earlier and better detection by a detection system. This will lead to more time for the driver or automated system to respond and reduce the probability of collisions and near misses. Thus, the patterns disclosed herein solve the problems stated above. The patterns are used to increase the visibility of users such as, but not limited to, cyclists and pedestrians to the detection system.

### BRIEF DESCRIPTION OF THE DRAWINGS

A full understanding of the invention can be gained from the following description of the preferred embodiments when read in conjunction with the accompanying drawings in which:

FIG. 1 is a schematic view of a vehicle including a detection system and a user wearing a portable article.

FIG. 2 is a schematic view of an accessory including a pattern.

FIG. 3 is a schematic front view of a shirt including various patterns.

FIG. 4 is a schematic front view of another shirt including various patterns.

FIG. 5A is a schematic front view of another shirt including a pattern. FIG. 5B is a schematic back view of a shirt including a pattern.

FIG. 6 is a schematic front view of a shirt including a 3D pattern. FIG. 6A is a detailed view of a 3D material.

FIG. 7 is a schematic front view of another shirt including a 3D pattern. FIG. 7A is detailed view of another 3D material.

### DESCRIPTION OF THE PREFERRED EMBODIMENTS

It will be appreciated that the specific elements illustrated in the figures herein and described in the following specification are simply exemplary embodiments of the disclosed concept, which are provided as non-limiting examples solely for the purpose of illustration. Therefore, specific dimensions, orientations, assembly, number of components used, embodiment configurations and other physical characteristics related to the embodiments disclosed herein are not to be considered limiting on the scope of the disclosed concept.

Directional phrases used herein, such as, for example, clockwise, counterclockwise, left, right, top, bottom, upwards, downwards and derivatives thereof, relate to the orientation of the elements shown in the drawings and are not limiting upon the claims unless expressly recited therein.

As used herein, the singular form of “a,” “an,” and “the” include plural references unless the context clearly dictates otherwise.

As used herein, “structured to [verb]” means that the identified element or assembly has a structure that is shaped, sized, disposed, coupled and/or configured to perform the identified verb. For example, a member that is “structured to move” is movably coupled to another element and includes elements that cause the member to move or the member is otherwise configured to move in response to other elements or assemblies. As such, and as used herein, “structured to [verb]” recites structure and not function. Further, as used herein, “structured to [verb]” means that the identified element or assembly is intended to, and is designed to, perform the identified verb. Thus, an element that is merely capable of performing the identified verb but which is not intended to, and is not designed to, perform the identified verb is not “structured to [verb].”

As used herein, “associated” means that the elements are part of the same assembly and/or operate together, or, act upon/with each other in some manner. For example, an automobile has four tires and four hub caps. While all the elements are coupled as part of the automobile, it is understood that each hubcap is “associated” with a specific tire.

As used herein, a “coupling assembly” includes two or more couplings or coupling components. The components of a coupling or coupling assembly are generally not part of the same element or other component. As such, the components of a “coupling assembly” may not be described at the same time in the following description.

As used herein, a “coupling” or “coupling component(s)” is one or more component(s) of a coupling assembly. That is, a coupling assembly includes at least two components that are structured to be coupled together. It is understood that the components of a coupling assembly are compatible with each other. For example, in a coupling assembly, if one coupling component is a snap socket, the other coupling component is a snap plug, or, if one coupling component is a bolt, then the other coupling component is a nut.

As used herein, a “fastener” is a separate component structured to couple two or more elements. Thus, for example, a bolt is a “fastener” but a tongue-and-groove coupling is not a “fastener.” That is, the tongue-and-groove elements are part of the elements being coupled and are not a separate component.

As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other. Accordingly, when two elements are coupled, all portions of those elements are coupled. A description, however, of a specific portion of a first element being coupled to a second element, e.g., an axle first end being coupled to a first wheel, means that the specific portion of the first element is disposed closer to the second element than the other portions thereof. Further, an object resting on another object held in place only by gravity is not “coupled” to the lower object unless the upper object is otherwise maintained substantially in place. That is, for example, a book on a table is not coupled thereto, but a book glued to a table is coupled thereto.

As used herein, the phrase “removably coupled” or “temporarily coupled” means that one component is coupled with another component in an essentially temporary manner. That is, the two components are coupled in such a way that the joining or separation of the components is easy and would not damage the components. For example, two components secured to each other with a limited number of readily accessible fasteners, i.e., fasteners that are not difficult to access, are “removably coupled” whereas two components that are welded together or joined by difficult to access fasteners are not “removably coupled.” A “difficult to access fastener” is one that requires the removal of one or more other components prior to accessing the fastener wherein the “other component” is not an access device such as, but not limited to, a door.

As used herein, “temporarily disposed” means that a first element(s) or assembly (ies) is resting on a second element(s) or assembly(ies) in a manner that allows the first element/assembly to be moved without having to decouple or otherwise manipulate the first element. For example, a book simply resting on a table, i.e., the book is not glued or fastened to the table, is “temporarily disposed” on the table.

As used herein, “operatively coupled” means that a number of elements or assemblies, each of which is movable between a first position and a second position, or a first configuration and a second configuration, are coupled so that as the first element moves from one position/configuration to the other, the second element moves between positions/configurations as well. It is noted that a first element may be “operatively coupled” to another without the opposite being true.

As used herein, “correspond” indicates that two structural components are sized and shaped to be similar to each other and may be coupled with a minimum amount of friction. Thus, an opening which “corresponds” to a member is sized slightly larger than the member so that the member may pass through the opening with a minimum amount of friction. This definition is modified if the two components are to fit “snugly” together. In that situation, the difference between the size of the components is even smaller whereby the amount of friction increases. If the elements defining the opening and/or the component inserted into the opening are made from a deformable or compressible material, the opening may even be slightly smaller than the component being inserted into the opening. With regard to surfaces, shapes, and lines, two, or more, “corresponding” surfaces, shapes, or lines have generally the same size, shape, and contours.

As used herein, a “path of travel” or “path,” when used in association with an element that moves, includes the space an element moves through when in motion. As such, any element that moves inherently has a “path of travel” or “path.” Further, a “path of travel” or “path” relates to a motion of one identifiable construct as a whole relative to another object. For example, assuming a perfectly smooth road, a rotating wheel (an identifiable construct) on an automobile generally does not move relative to the body (another object) of the automobile. That is, the wheel, as a whole, does not change its position relative to, for example, the adjacent fender. Thus, a rotating wheel does not have a “path of travel” or “path” relative to the body of the automobile. Conversely, the air inlet valve on that wheel (an identifiable construct) does have a “path of travel” or “path” relative to the body of the automobile. That is, while the wheel rotates and is in motion, the air inlet valve as a whole, moves relative to the body of the automobile.

As used herein, the statement that two or more parts or components “engage” one another means that the elements exert a force or bias against one another either directly or through one or more intermediate elements or components. Further, as used herein with regard to moving parts, a moving part may “engage” another element during the motion from one position to another and/or may “engage” another element once in the described position. Thus, it is understood that the statements, “when element A moves to element A first position, element A engages element B,” and “when element A is in element A first position, element A engages element B” are equivalent statements and mean that element A either engages element B while moving to element A first position and/or element A either engages element B while in element A first position.

As used herein, “operatively engage” means “engage and move.” That is, “operatively engage” when used in relation to a first component that is structured to move a movable or rotatable second component means that the first component applies a force sufficient to cause the second component to move. For example, a screwdriver may be placed into contact with a screw. When no force is applied to the screwdriver, the screwdriver is merely “coupled” to the screw. If an axial force is applied to the screwdriver, the screwdriver is pressed against the screw and “engages” the screw. However, when a rotational force is applied to the screwdriver, the screwdriver “operatively engages” the screw and causes the screw to rotate.

As used herein, “depending” means to extend at an angle other than zero (0°) from another element without regard to direction. That is, for example, a “depending” sidewall may extend generally upwardly from a base. Further, a “depending” sidewall inherently has a distal end.

As used herein, the word “unitary” means a component that is created as a single piece or unit. That is, a component that includes pieces that are created separately and then coupled together as a unit is not a “unitary” component or body.

As used herein, the term “number” shall mean one or an integer greater than one (i.e., a plurality). Thus, for example, a “number of elements” means one element or a plurality of elements.

As used herein, in the phrase “[x] moves between its first position and second position,” or, “[y] is structured to move [x] between its first position and second position,” “[x]” is the name of an element or assembly. Further, when [x] is an element or assembly that moves between a number of positions, the pronoun “its” means “[x],” i.e., the named element or assembly that precedes the pronoun “its.”

As used herein, “about” in a phrase such as “disposed about [an element, point or axis]” or “extend about [an element, point or axis]” or “[X] degrees about an [an element, point or axis],” means encircle, extend around, or measured around. When used in reference to a measurement or in a similar manner, “about” means “approximately,” i.e., in an approximate range relevant to the measurement as would be understood by one of ordinary skill in the art.

As used herein, a “radial side/surface” for a circular or cylindrical body is a side/surface that extends about, or encircles, the center thereof or a height line passing through the center thereof. As used herein, an “axial side/surface” for a circular or cylindrical body is a side that extends in a plane extending generally perpendicular to a height line passing through the center. That is, generally, for a cylindrical soup can, the “radial side/surface” is the generally circular sidewall and the “axial side(s)/surface(s)” are the top and bottom of the soup can. Further, as used herein, a “radially extending surface” means a surface defined by a plane that extends generally along a radial line and/or a surface that is generally perpendicular to an axial surface.

As used herein, “generally curvilinear” includes elements having multiple curved portions, combinations of curved portions and planar portions, and a plurality of planar portions or segments disposed at angles relative to each other thereby forming a curve.

As used herein, “generally” means “in a general manner” relevant to the term being modified as would be understood by one of ordinary skill in the art.

As used herein, “substantially” means “for the most part” relevant to the term being modified as would be understood by one of ordinary skill in the art.

As used herein, “at” means on and/or near relevant to the term being modified as would be understood by one of ordinary skill in the art.

As used herein, a “portable body” means a construct that is structured to be worn by a user or coupled to a vehicle such as, but not limited to, a human powered vehicle, a bicycle, electric bicycle, an enhanced human powered vehicle, moped, or scooter, and includes “apparel,” “fashion apparel,” and “accessories” as those terms are defined below.

As used herein, “apparel” means garments structured to be worn by a human such as, but not limited to, uniforms, hats, shirts, sweatshirts, vests, pants/trousers, belts, socks, shoes, jackets/coats, gloves, booties/gaiters. “Apparel” also includes items that are structured for a specific activity or purpose such as, but not limited to, exercise apparel, e.g., leggings and safety glasses, hunting apparel, e.g., reflective vests, and seasonal apparel, e.g., scarves and parkas.

As used herein, “fashion apparel” means “apparel” that is not intended to be safety apparel (e.g., safety vests) and which one of skill in the art would not incorporate visual safety elements. “Fashion apparel” includes, but is not limited to, non-responder uniforms (e.g., school uniforms), indoor sport uniforms, camouflage apparel (which means apparel with a camouflage design and on a “camouflage pattern” as defined below), costumes, evening wear, and casual work wear (i.e., apparel that is acceptable on a “casual Friday”). “Fashion apparel” excludes first responder uniforms (i.e., police, fire, emergency medical services, and military uniforms), outdoor sports uniforms, reflective apparel, e.g., orange hunting vests), and similar apparel.

As used herein, “accessory” means an object that is carried by a human or other creature as well as apparel-like objects for non-humans. That is, a sport equipment, a helmet, a purse, a briefcase, a walker, a wheelchair and a vest for a service animal are non-limiting examples of “accessories.” Further, an “accessory” includes an element that is structured to be temporarily coupled to another element such as apparel or another accessory. For example, a patch structured to be coupled to a backpack by a hook-and-loop coupling component is an “accessory.”

As used herein, “sport equipment” means non-apparel items that are used for sport and leisure activities such as, but not limited to, backpacks, fanny packs/bum bags, gym bags, skateboards, bicycles, water bottles, and animal leashes/rigs.

As used herein, a “pattern” means an indicia and includes, but is not limited to, indicia that a detection system is structured to identify. Further, a “pattern” means an indicia that performs a function in relation to the element and/or substrate upon which, or in which, the pattern is disposed. That is, if the indicia does not perform a function in relation to the element and/or substrate upon which, or in which, the pattern is disposed, then the indicia is not a “pattern” as defined herein. An aesthetically pleasing design, for example, a “tie-dye” design, is not a “pattern” as such a design does not serve a function other than being pleasing to the eye. A “pattern” is disposed on the surface of an element, disposed under the surface of an element, and/or, integrated into an element. For example, a plaid pattern made from red and green threads or an “iron-on” decal defines a pattern on the surface of an element. A radar reflective foil disposed under a fabric is an example of a pattern disposed under the surface of an element. A fiber-optic construct woven into a fabric wherein the tips of the fiber-optic threads emit light or light emitting diodes incorporated into a fabric are examples of a pattern that is integrated into an element. It is understood that these are non-limiting examples. Further, the term “pattern” is selectably modified by a number of terms, each of which indicates a set of characteristics, including “public,” “detectable,” “invisible,” “embedded,” “invisible,” “orienting,” “collective,” “external,” “internal,” “illuminated,” “applied,” “audio” and “three dimensional,” (or “3D”) or any combination of these terms. For example, a “pattern” may be identified as a “public, detectable pattern” which means the pattern includes the characteristics of a “public” pattern as well as a “detectable” pattern.

As used herein, a “public” pattern means any indicia used in warning signage. As non-limiting examples, a triangle with a red or yellow border, a yellow diamond, and an orange diamond are all common warning signs and therefore these are “public patterns.”

As used herein, a “detectable” pattern” means a pattern made from a material that is specifically structured to be, and is, detectable by a detection system or which includes a design/configuration that is not found naturally and is therefore detectable by a detection system. Further, a “detectable” pattern” means a pattern structured to generate information related to the vector (i.e., position and speed/velocity) of the pattern. The term “detectable pattern” is also modified herein by the terms “radar,” “laser,” “lidar,” “sonar,” “camera,” or any other electromagnetic detection technologies. “Lidar” also includes the sub-categories of infrared light, visible light, and ultra-violet light. The modifiers, as used herein, indicate the specific type of detection system by which the “detectable pattern” is structured to be detected and what type of wave the material is structured to, and does, reflect. As used herein, a “wave” means an electromagnetic construct, such as, but not limited to, a light wave or radar wave, as well as an audio construct such as, but not limited to, a sound wave, sonar wave or ultrasound wave. When appropriate, a “wave” is also identified as “light.” For example, a “radar detectable pattern” is made from a material that is structured to, and does, reflect radio wave, a “laser detectable pattern” is made from a material that is structured to, and does, reflect laser light,” a “lidar detectable pattern” is made from a material that is structured to, and does, reflect light, a “visible light detectable pattern” is made from a material that is structured to, and does, reflect visible light, and so forth. A “sonar” pattern is a pattern structured to reflect sound waves. An element such as, but not limited to, a traffic sign, i.e., a “public” pattern is, by itself, not a “detectable” pattern” in that such a sign is not specifically structured to be detectable by a detection system. A pattern, however, can be both “public” and “detectable.” For example, a wooden traffic sign that has a radar reflective element disposed in a pattern therein is a “public, detectable pattern.”

As used herein, a “radar enhancing” pattern is a pattern that includes radar enhancing elements which are structured to, and do, reflect radar energy directly back to a number of transmitting radar antenna, transceivers or radar receivers.

As used herein, an “orienting” pattern means a pattern that includes or provides information that a detection system uses to determine “characteristics of the construct” upon which the “orienting” pattern is disposed. The “characteristics of the construct” as used herein means any of orientation, position, direction, and speed. For example, an “orienting” pattern, in an exemplary embodiment, includes a triangle with a red border that is a specific size. When provided with data relevant to the orienting triangle pattern, a detection system is structured to, and does, determine the distance between the orienting triangle pattern and the detection system sensor based upon the apparent size of the orienting triangle pattern. That is, if the orienting triangle pattern appears small when detected by the detection system sensor, it is far away. Conversely, if the orienting triangle pattern appears large when detected by the detection system sensor, it is near. The detection system is structured to, and does, determine a generally accurate distance based upon the apparent size of the orienting triangle pattern. An “orienting” pattern is also structured to, and does, determine movement and speed vectors.

As used herein, a “collective” pattern means a pattern that includes a plurality of smaller patterns, wherein the smaller patterns are structured to be detected by different types of sensors.

As used herein, a “visible” pattern means that the pattern is visible and obvious to the human eye.

As used herein, an “embedded” pattern means that the pattern is visible to the human eye but which is incorporated in an unobtrusive manner into another image or pattern. As used herein, “in an unobtrusive manner” means that the embedded pattern is inconspicuous relative to the other image or pattern. For example, in a checkerboard pattern, selected squares with a slight variation in hue form an “embedded” pattern. As another example, in an image of a star filled night sky, selected stars are made from a reflective material form an “embedded” pattern.

As used herein, a “camouflage” pattern is not generally visible to the human eye. That is, a camouflage pattern blends in with a visible pattern, image, or background color(s). For example, an image of a forest including a plurality of vertical tree trunks which has an image of a typical “bar code” incorporated into the plurality of vertical tree trunks is an image including a “camouflage” pattern.

As used herein, an “invisible” pattern is not visible to the human eye. That is, the pattern reflects light that cannot be detected by the human eye. For example, in an image that appears as all black to the human eye but which also includes an image of a bar code that is detectable by a radar sensor; the bar code is an “invisible” pattern.

As used herein, an “external” pattern means a pattern disposed on, or partially on, the surface of the element including the pattern. For example, a coating sprayed on a fabric, or threads woven into the fabric wherein portions of the threads are exposed, are “external” patterns.

As used herein, an “internal” pattern means a pattern disposed beneath the surface of the element including the pattern. For example, a radar detectable pattern disposed under fabric is an “internal” pattern. An “internal” pattern is not directly visible to the human eye.

As used herein, an “illuminated” pattern means a pattern that emits light, i.e., wherein the light is not a reflected wave. The light includes infrared light, visible light, and ultra-violet light.

As used herein, an “applied” pattern means that the pattern is not part of, or formed with, the substrate or element upon which the pattern is located. For example, a pattern that is applied as a coating is an “applied” pattern. Similarly, a pattern that is initially on one substrate that is subsequently transferred to another substrate, i.e., a decal, is an “applied” pattern.

As used herein, a “three dimensional” or “3D” pattern means a pattern structured to provide a detection system with data structured to assist in determining any, or all, of the distance, orientation, rotation, speed, direction, velocity of the element upon/in which the pattern is disposed. Further, a “3D” pattern means a pattern structured to reflect a wave regardless of orientation. That is, when a flashlight is shining directly on a reflective flat surface, i.e., ninety degrees to the flat surface, most of the light is reflected back to the flashlight, where the angle of incidence at 90 degrees creates the maximum reflective surface. When the surface is angled relative to the flashlight, some of the light is reflected away from the flashlight. Moreover, the more acute the angle, the more light is reflected in a direction other than back to the flashlight. As used herein, a “3D” pattern means a pattern structured to reflect a wave in substantially any orientation. In one exemplary embodiment, a “3D” pattern is similar to a staircase; that is, rather than a single planar surface, there are multiple planar surfaces at ninety degree angles to each other. Stated alternately, the planar surfaces face two different directions. When a pattern is in this shape, a flashlight shining directly (at ninety degrees to) a first surface is then shining at zero degree to a second surface. Thus, the first surface reflects most of the light back to the flashlight. When this exemplary 3D pattern is moved/rotated, the flashlight is no longer at ninety degrees relative to the first surface, but is also not at zero degrees to the second surface. Thus, the first surface reflects less of the light, but the second surface reflects more of the light. Accordingly, in a 3D pattern, at least some of the light is reflected at the source of the light. That is, at least one surface is not parallel to the source of a wave and is therefore somewhat reflective. Further, a “3D” pattern, in an exemplary embodiment, includes a retroreflector (sometimes called a retroflector or cataphote) which is a device or surface that reflects light back to its source with a minimum of scattering. In a retroreflector, an electromagnetic wavefront is reflected back along a vector that is parallel to but opposite in direction from the wave's source.

Further, an “enhanced three dimensional” pattern is a “three dimensional” pattern that is structured so as to have an increased reflectivity when in motion compared to when the “three dimensional” pattern is not in motion. For example, an “enhanced three dimensional” pattern includes elements having multiple facets wherein the elements/facets face more than two directions and are structured to reflect a wave/light. It is understood that when such a pattern is in motion, the wave/light does not reflect constantly from the elements/facets; thus, the pattern is more easily detected. As an example of a generally random “enhanced three dimensional” pattern, a reflective surface is made from aluminum foil that has been randomly crumpled into a ball, then reformed into a generally planar sheet. The foil will have many creases and deformations that form “facets” that each reflect light at different angles. Thus, a light source may be directly reflected from one facet in a first orientation, and, directly reflected from another facet in a different orientation.

As used herein, “productive” location(s) for a pattern disposed on a portable body means that the pattern is disposed at a location or locations structured to provide a substantial amount of usable information to a detection system. It is understood that such “productive” locations may, or may not be, the same locations where an indicia would communicate usable information to a human. For example, a pattern disposed on the back of the shirt of a bicycle rider would communicate usable information to a human as well as a detection system. Conversely, a pattern disposed on the back of the knee area of the pants/trousers of a bicycle rider would likely not communicate usable information to a human but would communicate usable information to a detection system.

As used herein, and for a “collective” pattern, a “collaborative” configuration for the patterns in the “collective” pattern means that the pattern includes a selected number of patterns of selected size(s) which are disposed at locations structured to provide an enhanced amount of usable information to a detection system. As used herein, “an enhanced amount of usable information” means that the pattern increases the cross-section of the pattern and provides information to the detection system related to the motion and the prediction of motion of the object having the pattern.

As used herein, an “identifier” is a pattern that is structured to be, and is, associated with a specific set of characteristics that are generally unique and which are associated with the nature of the object having the “identifier.” For example, a white cane (which is typically associated with a visual impairment) includes an “identifier” which the imaging system associates with a person having a visual impairment. As used herein, “generally unique” means that a pattern or identifier is created specifically for the disclosed specific set of characteristics and that any other instances of the pattern or identifier is not associated with the specific set of characteristics.

As used herein, “light” means electromagnetic radiation and includes one or more of visible light, infrared light, ultraviolet light as well as gamma rays, X-rays, microwaves and radio waves.

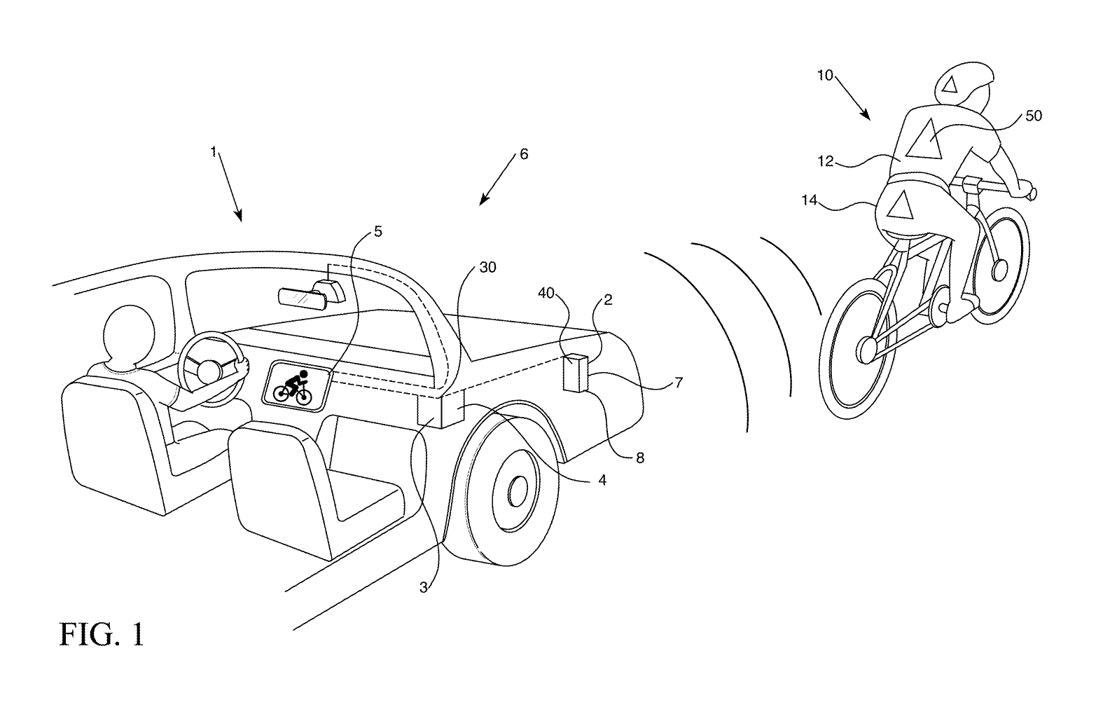

As shown in FIG. 1, generally a detection system 1 (shown schematically) includes a sensor assembly 2, a communication device 3, a processor device 4, and an output device 5. In an exemplary embodiment, the detection system 1 includes one, or both, of an imaging system 30 and/or an audio sensor assembly 40. Hereinafter, the following example will use an imaging system 30 as representative of the detection system 1. In an exemplary embodiment, the detection system 1, or imaging system 30, is part of a self-driving vehicle 6. In one embodiment, the sensor assembly 2 includes a transmitter system 7 that is structured to, and does, transmit light or light of a selected frequency such as, but not limited to, radio waves. In this embodiment, the sensor assembly 2 also includes a receiver assembly 8 that is structured to, and does, receive, or detect, light of generally the same frequency associated with the transmitter system 7. Known sensor assemblies 2 include, but are not limited to, radar (radio detection and ranging), lidar (light detection and ranging), laser range finders, cameras, sonar (sound navigation and ranging), and other electromagnetic methods of detection.

In another embodiment, the sensor assembly 2 does not include a transmitter system 7 and is limited to a receiver assembly 8. Such receiver assemblies 8 include, but are not limited to, a camera and a video camera, including digital embodiments of such cameras.

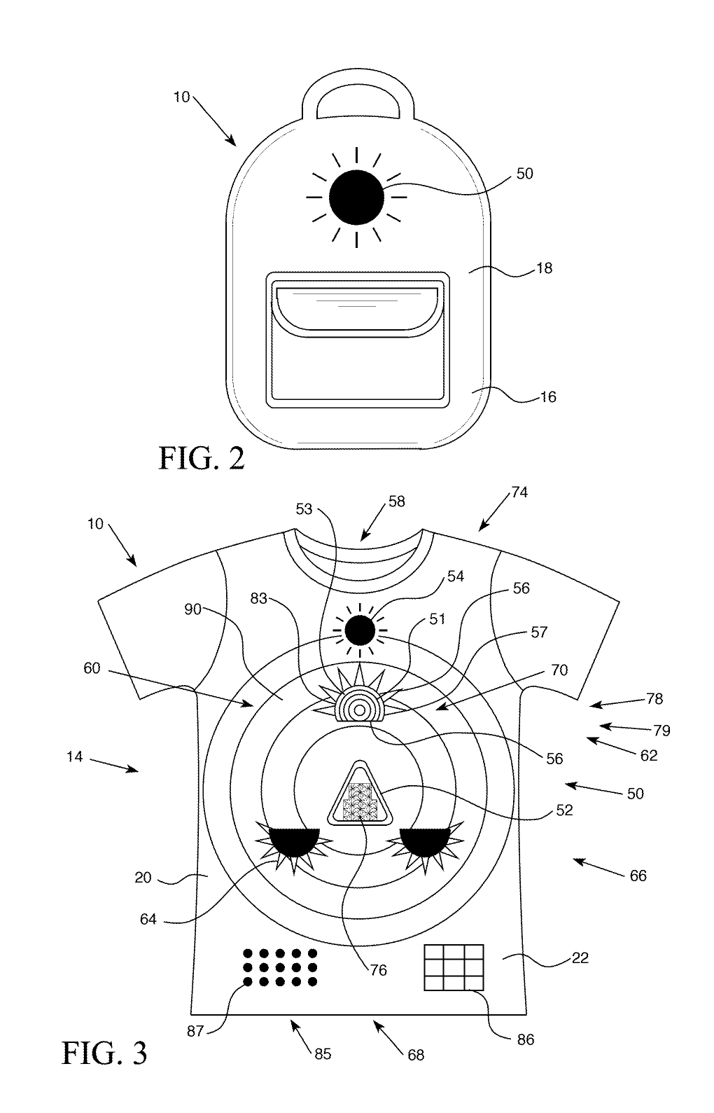

FIG. 1 also shows a user employing a portable article 10 structured to be recognized by a detection system 1. In an exemplary embodiment, the portable article 10 is one of apparel, fashion apparel, or an accessory. In the embodiment shown in FIG. 1, the portable article 10 is a shirt 12. It is understood, however, that the portable article 10 is, in an exemplary embodiment and as used herein, any article of apparel 14, any fashion apparel 15, an accessory 16, or a combination of different articles of apparel 14, fashion apparel 15, and/or an accessory 16. That is, as shown in FIG. 2, the portable article 10 is, in another embodiment, an accessory 16 which is shown as a backpack 18. Other examples of apparel 14, any fashion apparel 15 or an accessory 16 with a pattern 50, discussed below, include a water bottle, a hat, a helmet, a shoe, a briefcase, and a safety vest (none shown). The following discussion will use the shirt 12 of FIG. 3 as an example.

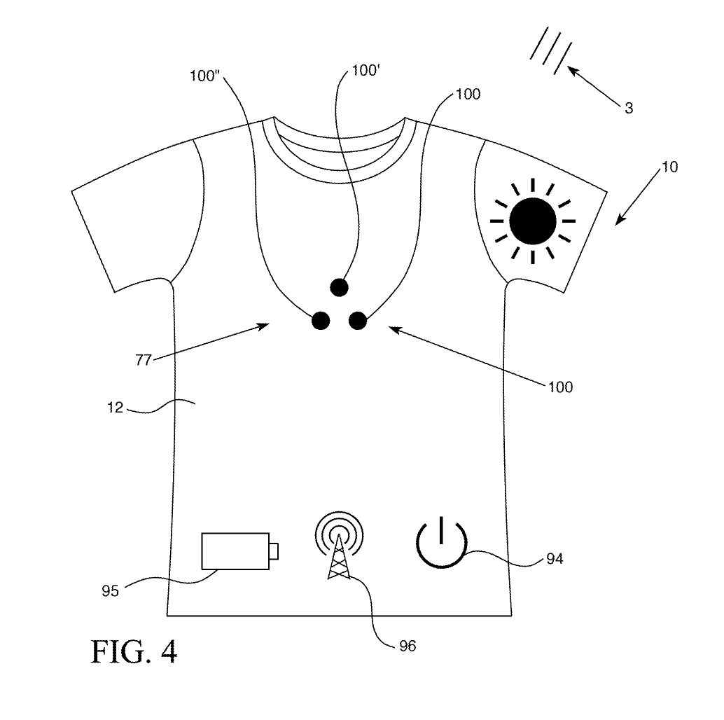

The portable article 10 includes a portable body 20 and a number of patterns 50 disposed at a number of productive locations on the portable body 20. Generally, the number of patterns 50 includes patterns 50 selected from the group including, consisting of, or consisting essentially of, public patterns 52 (shown as a warning triangle), detectable patterns 54 (shown as visible patterns 57 detectable by a camera), radar enhancing patterns 56 (shown as a pattern made from radar reflective beads 83), visible patterns 57 (shown as a decal of a sun pattern), embedded patterns 58 (in an exemplary embodiment, the radar reflective beads 83 are embedded in the fabric 22), camouflage patterns 60 (the reflective beads 83 embedded in the fabric 22 are not generally visible to the human eye), invisible patterns 62 (the reflective beads 83 are structured to reflect radar, a light that cannot be detected by the human eye), orienting patterns 64 (the “sun on the horizon” shown as an asymmetrical pattern about a generally horizontal axis and, as such, a detection system 1 can use the orienting patterns 64 to, for example, determine the orientation of the shirt 12), collective patterns 66, external patterns 68, and internal patterns 70. Further, as shown in FIG. 4, a portable article 10, again shown as a shirt 12, includes an illuminated pattern 72. That is, the shirt 12 in this embodiment includes a power source 95 that is in electrical communication with embedded light emitting diodes (LEDs) 100, applied patterns 74 (FIG. 3, as noted above the pattern is a decal applied to the fabric 22), and three dimensional patterns 76. As used herein and generally, the reference number “50” is used to identify all patterns 50 which also include one or more of the characteristics identified above. That is, hereinafter, any pattern 50 is identified generically by the reference number “50” and reference numbers 52-76 are not generally used. Further, it is understood that a pattern 50, in an exemplary embodiment, has more than one characteristic and, as such, a single pattern 50 is used to demonstrate multiple characteristics.

For example, as shown in FIG. 3, the portable body 20 is fabric 22 configured as a shirt 12. In an exemplary embodiment, the pattern 50 (one shown) is structured to be detectable by a detection system 1, i.e., the imaging system 30. That is, the pattern(s) 50 is/are made from a material structured to reflect light. In an exemplary embodiment, the pattern 50 is made from a radar reflective material wherein the reflective elements are spaced by 0.046 inch or less, but not zero spacing. As is known, reflective elements spaced by this amount are generally detected as solid by radar detectors. Alternatively, the pattern 50 is made of a material structured to reflect sound waves, hereinafter a “sonar” material 89, shown schematically in FIG. 4. That is, in FIG. 4, the sun pattern 50 is a sonar reflecting element or “sonar pattern” 88.

The pattern 50, in an exemplary embodiment, includes a series of concentric circles 51, as shown in FIG. 3, made from a wave reflecting material. Further, the pattern 50 is printed on, or applied to, the outer surface of the fabric 22 with an ink and is visible to the human eye. The pattern 50, however, is disposed within a circular image 53. Thus, the pattern 50 is “embedded” into the circular image. In this embodiment, the pattern 50 is a detectable, visible, embedded, external, applied pattern 50. Further, the pattern 50 is disposed in a productive location which, as shown, is on the front torso of the shirt 12. As shown in FIG. 3, a number of patterns 50 are disposed at a plurality of locations including multiple locations on the torso as well as on each shoulder. Thus, the patterns 50 are in both a collective pattern 78 and a collaborative configuration 79.

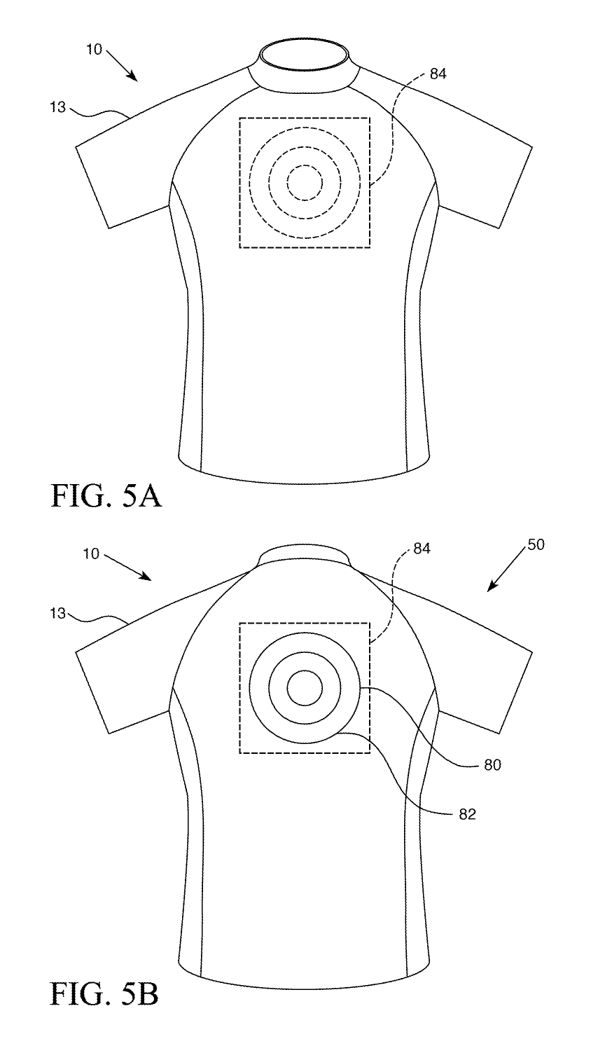

In another exemplary embodiment, shown in FIGS. 5A and 5B, the portable body 20 is again a fabric 22 configured this time as a jacket 13. The jacket 13 has multiple layers of material including an exterior layer (not numbered) and a liner (shown schematically). In this embodiment, the pattern 50 is a radar detectable pattern 50 made from a material selected from the group including, consisting of, or consisting essentially of, a retroreflective material 80 and a metallic thread 82. The radar detectable pattern 50 is provided on an insert 84 that is disposed between the leather exterior and the liner. Thus, in this example, the pattern 50 is a radar detectable, internal pattern 50. Further, in an embodiment wherein the retroreflective material 80, such as, but not limited to glass beads 87 (shown schematically) cannot be seen by the human eye, the pattern 50 is a radar detectable, invisible, internal pattern 50.

In an exemplary embodiment, a radar detectable, invisible, internal pattern 50 includes radar reflecting elements disposed in a grid-like configuration. That is, in this embodiment a shirt 12 includes discrete radar reflecting elements 85 such as, but not limited to glass beads 87, disposed in a grid and spaced about 0.046 inch apart. In FIG. 4, the radar reflecting elements 85 are disposed over substantially all surfaces of the shirt 12. In another embodiment, not shown, the radar reflecting elements 85 are disposed in selected locations and/or productive location. That is, as shown, the radar reflecting elements 85 are disposed at the shoulders and in a limited area of the torso. Further, in an exemplary embodiment, the radar reflecting elements 85 are in electrical communication with each other via a number of conductors (not shown).

In another exemplary embodiment, the pattern 50 includes a radar detectable pattern 50 that is structured to be selectably actuated or automatically actuated by the detection system 1. That is, in this embodiment, the radar reflecting elements 85 include a semiconductor or selectively conductive material. For example, in one embodiment, the radar detectable pattern 50 includes conductive threads 86 or reflective beads 87 that are conductive and can be sequenced on/off. Alternatively, as shown, the pattern 50 is an illuminated pattern 72 that includes LEDs 100. The LEDs 100 are structured to illuminate in a selected sequence; for example, as shown in FIG. 4, a first LED 100′ a second LED 100″, and a third LED 100″′. The user actuates the reflective/illuminating property, for example, by a switch 95. Alternatively, the portable article 10 includes a receiver 96 and a programmable logic circuit (not shown). In this embodiment, the detection system 1 broadcasts a signal that, when detected by the portable article's receiver 96 and a programmable logic circuit, causes the illuminated pattern 72 to be actuated. Further, in an exemplary embodiment, the programmable logic circuit illuminates the LEDs 100 in a sequence that provides additional information to the detection system 1. For example, the LEDs 100 will illuminate from left to right thereby informing the detection system 1 of the orientation of the illuminated pattern 72. That is, the detection system 1 is structured/programmed to understand how the LEDs 100 will illuminate and thereby convey additional information to the detection system 1. Such a pattern 50 having an associated detection system 1 is, as used herein, a “handshake” pattern 77. That is, a pattern that is structured to convey additional information to the detection system 1 and wherein the detection system 1 is structured to actuate the pattern 50 so as to provide the additional information, is a “handshake” pattern.

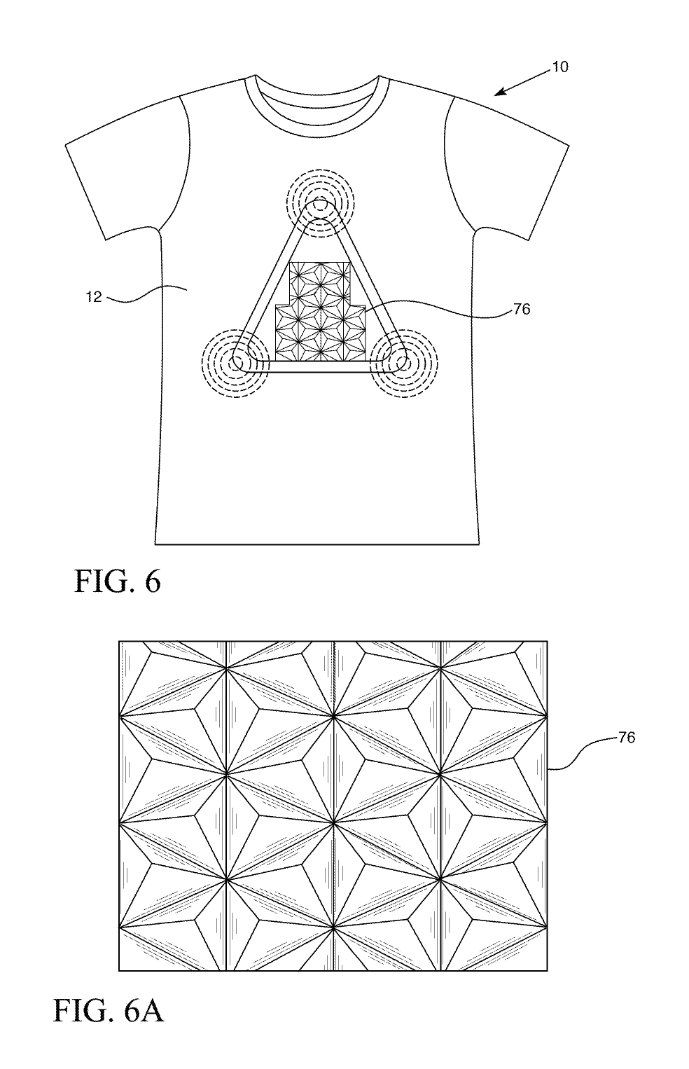

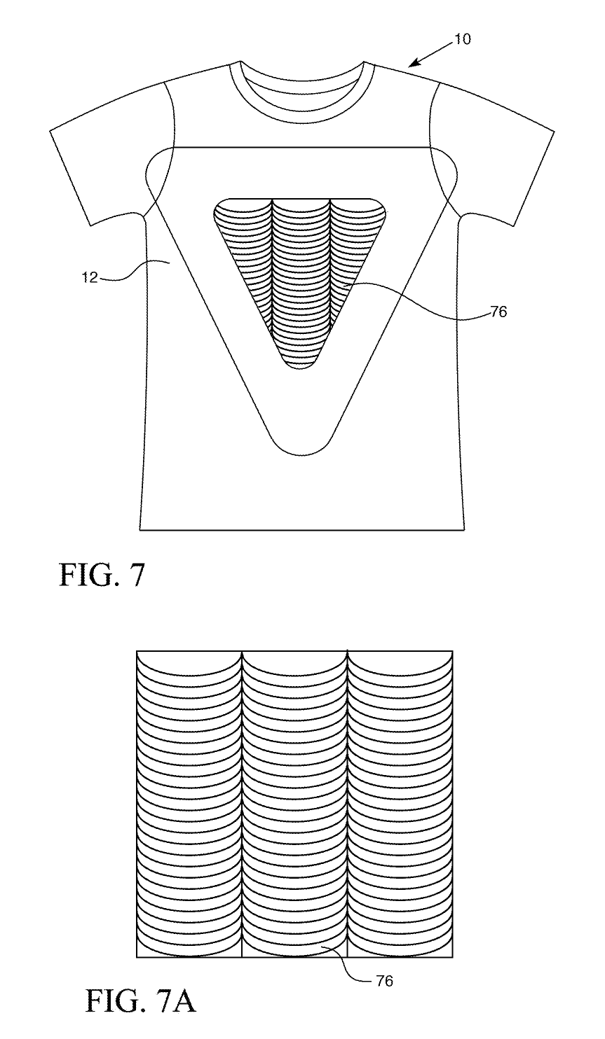

As shown in FIGS. 6 and 6A, a 3D pattern 76 includes a material, such as, but not limited to, a radar reflective material, having multiple facets. As discussed in the definition of a “3D” pattern, the multiple facets are configured so that at least one surface is not parallel to the source of a wave and the 3D pattern 76 is therefore somewhat reflective regardless of orientation relative to the detection system 1. As shown in FIG. 6A, the 3D pattern 76 is shown as a repeating pattern; it is understood this is not required and the pattern can be random such as a crinkled pattern shown in FIGS. 7 and 7A. In an exemplary embodiment, the 3D pattern 76 is an enhanced three dimensional pattern.

In another exemplary embodiment, the pattern 50 includes a collective, orienting pattern 64, 66. That is, the pattern 50 is structured to provide information that an imaging system uses to determine characteristics of the construct upon which the collective, orienting pattern 64, 66 is disposed. That is, as shown, the portable article 10 is a shirt 12 including a plurality of patterns 50 wherein the patterns 50 are asymmetrical about at least one axis. In this configuration, the patterns 50 are structured to be, and are, disposed at different orientations; in this configuration, the collective, orienting pattern 64, 66 such as identifying which direction is “up,” “right,” and “left.” That is, as shown, the orienting pattern 50 includes an “upward” sun pattern 90, a “right” sun pattern 92, and a “left” sun pattern 94. The detection system 1 is structured to identify in which direction the collective, orienting pattern 64, 66 is oriented based upon the relation of the sun patterns 90, 92, 94. This orientation, in an exemplary embodiment, is converted to Cartesian coordinate axes.

In another exemplary embodiment, the pattern 50 is an identifier. For example, in the embodiment shown, the portable article 10 is a white cane (not shown) which is associated with users with impaired vision. In this embodiment, the pattern 50, i.e., the identifier, is detectable by a detection system 1, and is associated with a specific set of characteristics that are generally unique and which are associated with the nature of the object having the identifier. That is, in this instance, the identifier is a pattern 50 that is generally unique and which is structured to be associated by a detection system 1 with a person having a visual impairment. It is understood that a white cane and impaired vision are one example and are not limiting upon the claims or this embodiment.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

What is claimed is:

1. A portable article structured to be recognized by a detection system, said portable article comprising:
a portable body; and
a number of patterns disposed on said portable body.

2. The portable article of claim 1 wherein said number of patterns includes patterns selected from the group consisting of public patterns, detectable patterns, radar enhancing patterns, visible patterns, embedded patterns, camouflage patterns, invisible patterns, orienting patterns, collective patterns, external patterns, internal patterns, illuminated patterns, applied patterns, a handshake pattern, and three dimensional patterns.

3. The portable article of claim 1 wherein:
said number of patterns includes a number of detectable patterns; and
said number of detectable patterns includes a radar detectable pattern.

4. The portable article of claim 3 wherein said radar detectable pattern includes a material selected from the group consisting of a retroreflective material and a metallic thread.

5. The portable article of claim 3 wherein said radar detectable pattern is structured to be selectably actuated.

6. The portable article of claim 1 wherein:
said number of patterns includes a number of detectable patterns;
said number of detectable patterns includes an orienting pattern; and
said orienting pattern including elements representing two Cartesian coordinate axes.

7. The portable article of claim 1 wherein:
said number of patterns includes a number of detectable patterns;
said number of detectable patterns includes an illuminated pattern; and
wherein said illuminated detectable pattern is structured to be selectably actuated.

8. The portable article of claim 1 wherein:
said number of patterns includes a number of detectable patterns;
said number of detectable patterns includes a collective pattern; and
said collective pattern disposed in a collaborative configuration.

9. The portable article of claim 1 wherein:
said number of patterns includes a number of detectable patterns;
said number of detectable patterns includes a three dimensional pattern; and
said three dimensional pattern is an enhanced three dimensional pattern.

10. The portable article of claim 1 wherein the pattern is an identifier.

11. The portable article of claim 1 wherein said patterns are disposed at a number of productive locations on said portable body.

12. The portable article of claim 1 wherein said portable body is apparel.

13. The portable article of claim 1 wherein said portable body is an accessory.

14. The portable article of claim 1 wherein said portable body includes a sonar pattern.
